(19) United States
(12) Patent Application Publication
(10) Pub. No.: US 2026/0163269 A1
(43) Pub. Date: Jun. 11, 2026

(54) PLUG CONNECTOR FOR PRINTED CIRCUIT BOARDS OF APPLIANCE COMPONENTS

(71) Applicant: BSH Hausgeräte GmbH, München (DE)

(72) Inventors: Wolfgang Mücke, Oranienburg (DE); Claus Plecher, Zeitlarn (DE)

(21) Appl. No.: 18/718,128

(22) PCT Filed: Dec. 7, 2022
(86) PCT No.: PCT/EP2022/084755

§ 371 Date: Jun. 10, 2024

(30) Foreign Application Priority Data
Dec. 8, 2021 (DE) 10 2021 213 942.6

(51) Int. Cl. H01R 12/72

(52) U.S. Cl. CPC H01R 12/721

(57) ABSTRACT

A plug connector for direct or indirect connection to a printed circuit board or any other appliance components, for example of a household appliance, is preferably of the insulation displacement type and is based on the RAST standard. The centers of contacts of individual contact pairs are each spaced from the contacts of a neighboring contact pair by 1.5 mm. A frame, a printed circuit board, a pin header and a plug connector system are also provided.

The invention relates to a plug connector for direct or indirect connection to a printed circuit board or any other appliance component, for example of a household appliance, according to the preamble of claim 1, a frame, a printed circuit board, a pin header and a plug connector system.

Modern electrical household appliances have a highly complex and highly sensitive electronics system. Mutual electromagnetic interference between electronic components such as processors and memory elements must be avoided at all costs to ensure trouble-free operation. The electrical and data connections between the electronic components and individual appliance components such as electric motors and heating devices are made via cables (wire outlet), which are connected to the printed circuit boards or P083 and the appliance components via plug-in connections. The electronic components themselves are usually positioned on the printed circuit boards. In the sector of household appliances, plug connector suppliers and appliance manufacturers have developed the RAST 2.5 plug connector as a standard. RAST 2.5 is an acronym for raster connection plug technology with a spacing of 2.5 mm between adjacent contact centers of the contact areas.

Due to the complexity of household appliances, the plug connectors are usually arranged on all four sides of a printed circuit board. Accordingly, the conductor tracks are routed over a large area of the printed circuit board. In order to protect against electromagnetic interference, however, it is favorable if the conductor tracks are located at a minimum distance from the electronic components of the printed circuit board. This can be achieved if the plug connectors are not arranged on all sides of a printed circuit board, but only on individual printed circuit board sides, for example two. This would create a free space on the printed circuit boards in which the sensitive electronic components could then be arranged, so that a minimum distance would be achieved between the electronic components and the conductor tracks that are not required for the respective electronic component. When using the standardized RAST 2.5 plug connectors, however, the printed circuit boards would have to be enlarged in order to arrange them only on individual printed circuit board sides without sacrificing functions.

The object of the invention is to create a plug connector, in particular for small household appliances, which has a more compact size than the RAST 2.5 plug connector with at least the same functionality. In addition, it is the object of the invention to create a frame and a pin header for such a plug connector, a printed circuit board for such a plug connector, frame and such a pin header as well as a plug connector system having such a plug connector.

The object is achieved by a plug connector having the features of claim 1, by a frame having the features of claim 5, by a pin header having the features of claim 7, by a printed circuit board having the features of claim 8 and by a plug connector system having the features of claim 9.

A plug connector in accordance with the invention for direct or indirect connection to a printed circuit board or any other appliance component, for example of a household appliance, has a housing which connects two opposing housing walls which are connected to each other via a head section. Contact areas for producing electrical or data connections to the printed circuit board or the other appliance components are located between the housing walls. The contact areas each have a contact pair having two opposing contacts which are laterally spaced from contacts of adjacent contact areas. In accordance with the invention, the contacts of the individual contact pairs are each spaced by 1.5 mm from the contacts of an adjacent contact pair.

The 1.5 mm spacing is measured between adjacent contact area centers or adjacent contact centers. The plug connector is preferably based on the so-called insulation displacement connector technology. By virtue of the procedure of using the spacing measurement of 1.5 mm between adjacent contact area centers, the installation space of the plug connector is reduced and the plug connector in accordance with the invention can be designed so as to be more compact than a plug connector according to RAST 2.5 with the same functionality. Consequently, it is possible to arrange all the necessary plug connectors only on a few sides of the printed circuit boards so that it is no longer necessary to route lines over the entire printed circuit board, on the contrary printed circuit board areas are created which have fewer conductor tracks and in which it is then possible to arrange electronic components. By way of example, household appliances are washing machines, tumble dryers, refrigerators and freezers, small kitchen appliances, cookers, ovens, microwaves, dishwashers and extractor hoods.

Cable connections that are arranged adjacent to each other in the head section are likewise preferably spaced from each other in each case by 1.5 mm, measured from cable connection center to cable connection center. This procedure renders it possible to design the internal electrical or data housing connections between the cable connections and the contact areas so as to be short.

In order to stabilize the plug connector housing in the area of the opposing housing walls, these can be connected to each other on one side of the housing via an end wall that extends essentially over the entire height of the housing walls.

In order to prevent inadvertent incorrect positioning of the plug connector in a slot not intended for this plug connector on the printed circuit board or appliance component side, outer-lying coding lugs can be arranged on at least one of the housing walls.

A frame in accordance with the invention for a plug connector in accordance with the invention is used to guide the plug connector when directly assembling printed circuit boards or appliance components, for example of a household appliance. It has a receiving space which enables the plug connector in accordance with the invention to be received and securely guided and to make direct contact with a corresponding connection area of a printed circuit board.

In order to secure the frame to the printed circuit board or the device component, it can have latching lugs for latching to the printed circuit board or other appliance component. Preferably, the securing mechanism can be released non-destructively without tools.

A pin header in accordance with the invention for a plug connector in accordance with the invention is used to receive the plug connector when directly assembling printed circuit boards or appliance components, for example of a household appliance. The pin header has a receiving space for receiving the plug connector in accordance with the invention and enables said plug connector to make reliable indirect contact with a corresponding connection area of a printed circuit board.

A printed circuit board in accordance with the invention for a plug connector in accordance with the invention, for a pin header in accordance with the invention or for a frame in accordance with the invention has correspondingly adapted slots, the conductor tracks of which are adapted to the 1.5 mm spacing of the contact areas on the plug connector side or to the connecting pins of the plug connector, according to one of the preceding claims.

A plug connector system in accordance with the invention preferably designed using insulation displacement connector technology has at least one plug connector in accordance with the invention and at least one printed circuit board in accordance with the invention which is configured for a direct or indirect connection of the plug connector. In addition, the plug connector system can have at least one pin header for an indirect connection of the plug connector to the printed circuit board and/or at least one frame for a direct connection of the plug connector to the printed circuit board.

Other advantageous exemplary embodiments are the subject of further subordinate claims.

Preferred exemplary embodiments of the invention are further explained with reference to greatly simplified schematic illustrations. In the drawings:

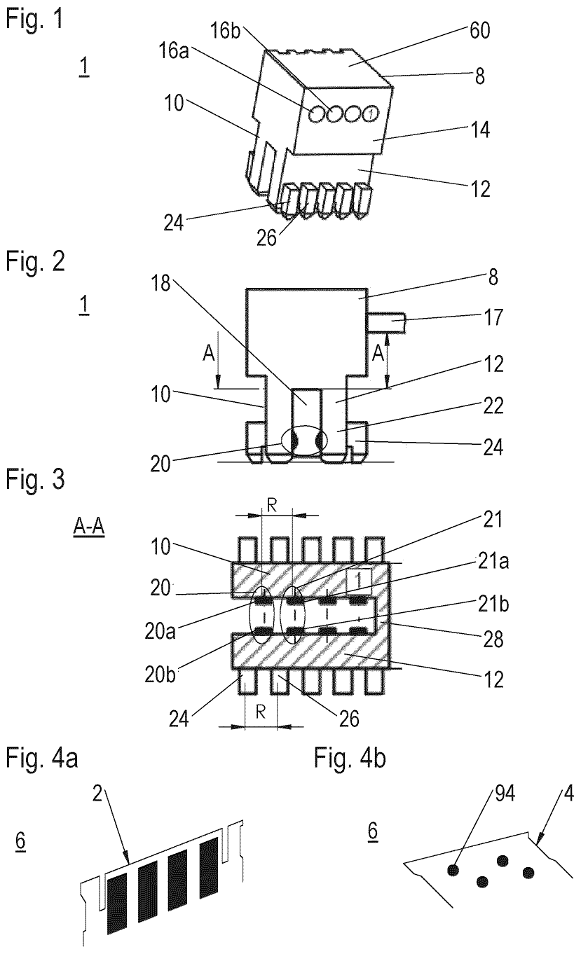

FIG. 1 shows a schematic illustration of a plug connector in accordance with the invention,

FIG. 2 shows a side view of the plug connector shown in FIG. 1,

FIG. 3 shows a horizontal section along the plane A-A in FIG. 2 through the plug connector shown in FIG. 1,

FIG. 4a shows a connection area in accordance with the invention for the direct contact of such a plug connector,

FIG. 4b shows a connection area in accordance with the invention for the indirect connection of such a plug connector,

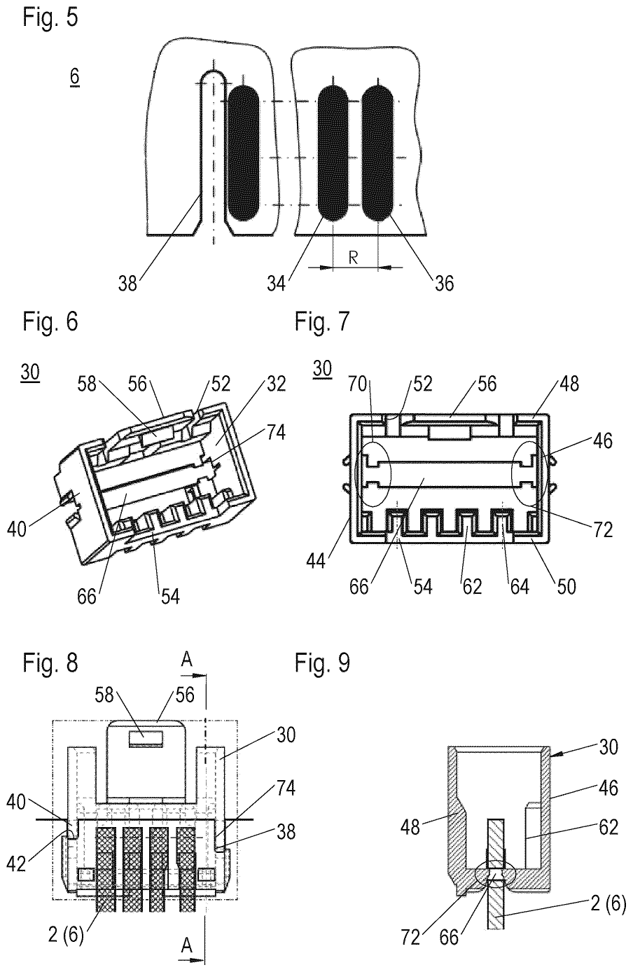

FIG. 5 shows a detailed illustration of a connection area in accordance with the invention of a printed circuit board in accordance with the invention for such a plug connector,

FIG. 6 shows a perspective illustration of a frame in accordance with the invention for such a plug connector,

FIG. 7 shows a plan view of the frame shown in FIG. 6,

FIG. 8 shows an assembly of the frame without a plug connector on a printed circuit board,

FIG. 9 shows a section through the assembly shown in FIG. 8 along the plane A-A in FIG. 8,

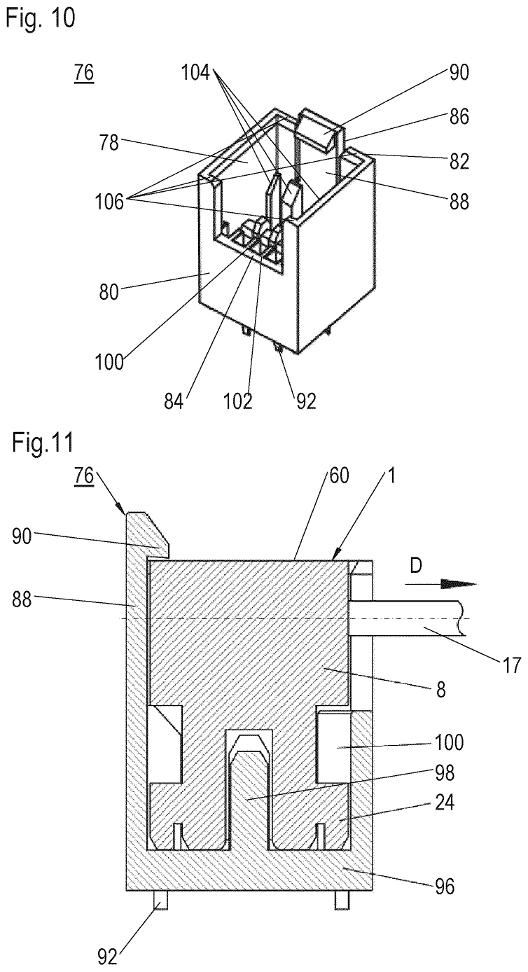

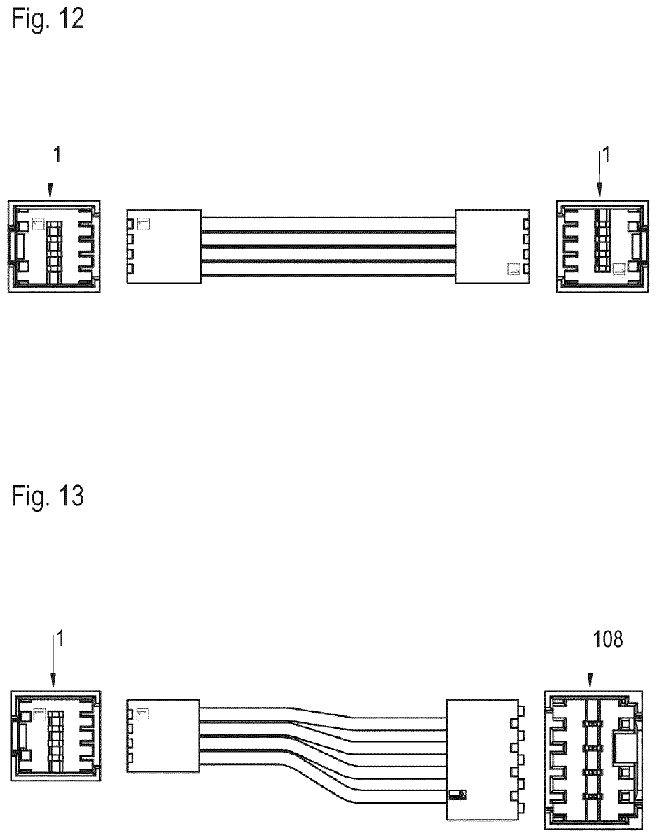

FIG. 10 shows a perspective illustration of a pin header for such a plug connector,

FIG. 11 shows a section through an assembly of the pin header with the received plug connector,

FIG. 12 shows an example of a parallel wiring between two plug connectors in accordance with the invention, and

FIG. 13 shows an example for a parallel wiring between the plug connector in accordance with the invention and a plug connector according to RAST 2.5.

FIGS. 1 to 3 show an exemplary embodiment of a plug connector 1 in accordance with the invention for the direct connection to a connection area 2 of a printed circuit board 4 (FIG. 4a) or for the indirect connection to a connection area 6 of the printed circuit board (FIG. 4b). The printed circuit board 4 is installed in an electrical appliance, in particular a household appliance, and is a component of its electronics system. By way of example, electronic components such as processors, chips or memories are arranged thereon. Alternatively, the plug connector 1 can also be connected to an appliance component such as an electric motor or an electrical heating facility of the household appliance. The plug connector 1 is used to transmit electrical currents and/or data signals of the electronics system.

FIGS. 1 and 3 show external views of the plug connector 1 and FIG. 3 shows a sectional view. The plug connector 1 is preferably based on the so-called insulation displacement connector technology.

The plug connector 1 has a head section 8 from which two opposing housing walls 10, 12 extend.

The head section 8 is cuboid and has on one of its long sides 14 in the illustrated exemplary embodiment four cable connections 16a, 16b for connecting four electrical or data cables 17 (wire outlet) to the plug connector. For reasons of clarity, only two cable connections 16a, 16b are numbered.

The housing walls 10, 12 are plate-like and their long sides are spaced from each other so that a parallel gap 18 is formed between them. Their long sides are evenly offset inwards in relation to the head section 8. Contact areas 20, 21 that lie adjacent to each other in the illustrated exemplary embodiment for direct or indirect connection to a correspondingly prepared printed circuit board 4 are located in the parallel gap 18 or between the housing walls 10, 12. For reasons of clarity, only two contact areas 20, 21 are numbered.

The contact areas 20, 21 each have two opposing electrical and/or data contacts 20a, 20b or 21a, 21b. The contacts 20a, 20b or 21a, 21b are located in the area of a free base section 22 of the housing walls 10, 12, said base section lying remote from the head section 8. In each case, one of the contacts 20a, 20b or 21a, 21b is arranged on the inside of one of the housing walls 10, 12. Together, two contacts 20a, 20b or 21a, 21b respectively of a contact area 20, 21 form a contact pair. The contact pairs are arranged at such a distance from each other that the contacts 20a, 20b or 21a, 21b of the respective adjacent contact areas 20, 21are spaced from each other by 1.5 mm, measured from contact center to contact center. In other words, the centers of the contact areas 20, 21 (contact area center) are each 1.5 mm apart (R=1.5 mm).

The conductive connection of the contacts 20a, 20b or 21a, 21b to the cable connections 16a, 16b is made internally through the head section 8 and the housing walls 10, 12 and is thus protected from external damage. In order to reduce the conductive cable connection lengths, the cable connections 16a, 16b on the head section side are also each located at a distance of 1.5 mm from each other, measured from cable connection center to cable connection center (R=1.5 mm).

In this exemplary embodiment, the housing walls 10, 12 each have four coding lugs 24, 26 in their base sections 22 on the outside on the long sides running in opposite directions to each other. For reasons of clarity, only two coding lugs 24, 26 are numbered. The coding lugs 24, 26 are laterally offset with respect to the contact areas 20, 21, but are preferably at a distance of 1.5 mm from each another, measured from center of the coding lug to center of the coding lug (R=1.5 mm). The coding lugs 24, 26 have such a width or the housing walls 10, 12 are offset inwards in relation to the head section 8 in such a way that the coding lugs 24, 26 do not protrude beyond the head section 8 (FIG. 2).

In order to stabilize the housing walls 10, 12, these can, as shown in this exemplary embodiment, be connected to each other via an end wall 28, which extends from the head section 8 along one of its end faces and ends at the level of the housing walls 10, 12 (same height as the housing walls 10, 12 or guided up to the base sections 22).

FIG. 5 shows a connection area 2 in accordance with the invention for the direct connection of the plug connector 1 in accordance with the invention to a printed circuit board 4. The plug connector can be arranged directly on the connection area 2 in two ways. It can be pushed freely onto the connection area 2 so that the connection area 2 is received into the parallel gap 18 between the housing walls 10, 12. Alternatively, a frame 30 or so-called guide frame or printed circuit board frame can be arranged on the connection area 2 and it defines a receiving space 32 into which the plug connector 1 is then inserted. Such a frame 30 is shown in FIGS. 6 and 7 when assembled with the plug connector 1 and when assembled with the connection area 2 in FIGS. 8 and 9.

The connection area 2 is correspondingly adapted to the plug connector 1 in accordance with the invention and accordingly has in this case four elongated conductor track connections 34, 36 that are next to each other at a distance which enables secure contacting with the contact pairs of the connector 1. For reasons of clarity, only two conductor track connections 34, 36 are numbered This means that the respective adjacent conductor track connections 34, 36 are each spaced from each other by 1.5 mm, measured from the center of the conductor track connections 34 to the center of the conductor track connections 36 (R=1.5 mm).

A guide slot 38 for receiving the end wall 28 of the plug connector or for receiving a wall section 40 of the frame 30 is provided in the printed circuit board 4 to the side of each of the two outer-lying conductor track connections 34, 36, only one guide slot can be recognized in FIG. 5 due to the section. Both guide slots 38, 42 can be recognized in FIGS. 4a and 8. The guide slots 38, 42 can have different lengths in order to prevent a twisted assembly of the frame 30 or of the plug connector 1 (see description of FIG. 8). In order to simplify the insertion of the frame 30 with its wall sections 40 or 74 of the plug connector 1 with its end wall 28, the guide slots 38, 42 are widened in a funnel shape on the opening side.

As shown in FIGS. 6, 7 and 8, the frame 30 has a cuboid outer contour that surrounds its receiving space 32, which enables insertion of the plug connector 1 with its housing walls 10, 12 without or almost without any play. The frame 30 has comparatively thin walls and is wider than the plug connector 1. In the inserted state, the plug connector 1 rests against the front and rear of the frame 30 with virtually no play, but is laterally spaced from opposing narrow sides 44, 46 of the frame 30 by a gap.

Long sides 48, 50 of the frame 30 each have a height-reduced, centrally arranged cut-out 52, 54 which can receive the head section 8. The plug connector 1 with its cable connections 16a, 16b on the head section side is inserted into one cut-out 52. A latching tab 56 extends from the opposing section 54, slightly offset to the outside so to speak, and in the inserted state rests in a form-locking manner against an upper side 60 (FIG. 1) of the head section 8 with a latching lug 58, so that the plug connector 1 is secured in position in the frame 30.

Close to the base, projections 62, 64 are formed on the inside of at least one long side, and it is possible to accommodate the coding lugs 24, 26 of one of the plug-side housing walls 10, 12 between said projections. As shown, the latching tab 56 can be arranged centrally on a long side 50 of the frame 30 or offset eccentrically towards one of the two narrow sides 44.

In addition, as shown in FIGS. 7 and 9, the frame has an elongated slot 66 on the base side for sliding onto the connection area 2. The elongated slot 66 extends over the entire width of the frame 30. In order to secure the position on the connection area 2, two latching hook pairs 70, 72 are formed in its base 68, the individual latching hooks of which are arranged opposite each other in the end areas of the elongated slot 66 in such a way that they protrude into the slot 66, so that the elongated slot 66 is reduced in cross-section in the area of the latching hook pairs 70, 72. The reduction in cross-section corresponds approximately to a thickness of the connection area 2. The other areas of the elongated slot 66 have a width that is greater than the thickness of the connection area 2. Due to the end-side arrangement of the latching hook pairs 70, 72, these engage laterally with the two outer conductor track connections 34, 36.

FIG. 8 shows the frame 30 with two narrow-sided wall sections 40, 74 being received into the two guide slots 38, 42 of the direct connection area 2, said two guide slots being arranged to the side of the conductor track connections 34, 36. The wall sections 40, 74 of the frame 30 correspond to the guide slots 38, 42 and, in this case in particular, are of different lengths in order to prevent inadvertent incorrect assembly of the frame 30.

FIGS. 10 and 11 show a pin header 76 in accordance with the invention for the indirect connection of the plug connector 1 in accordance with the invention to a connection area 4 of a printed circuit board 6.

The pin header 76, also known as the trough, has a cuboid outer shape with a receiving space 78 for receiving the plug 1. The receiving space 78 is designed to correspond to the plug connector 1 and allows the plug connector 1 to be arranged in the pin header 76 without or almost without any play (see FIG. 11).

The pin header 76 has comparatively thin walls and has a cut-out 84, 86 on each of two long sides 80, 82 (in relation to the inserted plug 1). One cut-out 84 is used to lead out the cables on the head section side connected to the plug connector 1. A latching tab 88 extends from the other cut-out 86 and the latching lug 90 of said latching tab rests form-lockingly against the upper side 60 of the head section 8 in the assembled state. As shown, the latching tab 88 can be arranged centrally on a long side 82 of the pin header 76 or eccentrically.

The pin header 76 is connected to the printed circuit board 4 via outer bottom-side contact pins 92, which have corresponding pin holes 94 (see FIG. 4b). The outer contact pins 92 are guided through a base plate 96 of the pin header 76 and are conductively connected to inner-lying contact points of the pin headers (not shown). The contact points are integrated in a wall 98, which extends vertically away from the base plate 96 and is received into the parallel gap 18 of the mounted plug 1. The contact points on the pin header side are likewise at a distance from adjacent contact points (center to center) of 1.5 mm (R=1.5 mm) and are thus adapted to the 1.5 mm spacing of the plug contacts 20a, 20b or 21a, 21b, so that reliable electrical or data signal transmission between the plug connectors 1 and the printed circuit board 4 is made possible by means of the pin header 76. Close to the base, projections 100, 102 are formed on the inside in the area of the free cut-out 86 and the coding lugs 24, 26 of a plug-side housing wall 10, 12 can be accommodated between said projections. As shown, the latching tab 88 can be arranged centrally on a long side of the plug connector 1 or eccentrically.

In order to facilitate assembly, the pin header 76 in this exemplary embodiment has three insertion bevels 104 in the area of the latching tab 88, which are raised (in a columnar manner) relative to their immediate surroundings in the receiving space 78. Due to the perspective, only two insertion bevels 104 can be recognized in FIG. 10.

In addition, the pin header 76 has lateral U-shaped guides 106, in this case tour guides 106, to facilitate the assembly of the plug 1 in the pin header 76.

FIG. 12 shows parallel wiring between two plug connectors 1 in accordance with the invention.

FIG. 13 shows parallel wiring between a conventional RAST 2.5 plug connector 108 and the plug connector 1 in accordance with the invention. The more compact size of the plug connector 1 in accordance with the invention can be clearly recognized in comparison with a RAST 2.5 plug connector 108.

A plug connector system in accordance with the invention has a plug connector 1 according to one of FIGS. 1, 2 and 3, and a printed circuit board 6 in accordance with the invention with at least one direct connection area 2 (FIGS. 4a, 5 and 8) and/or an indirect connection area 4 (FIG. 4b), and/or a frame 30 according to FIGS. 6, 7, 8 and 9, and/or a pin header 76 according to FIGS. 10 and 11.

Disclosed are a plug connector for direct or indirect connection to a printed circuit board or another appliance component, for example of a household appliance, preferably using insulation displacement connector technology and based on the RAST system, wherein the contacts of the individual contact pairs are spaced in each case by 1.5 mm from the contacts of an adjacent contact pair, a frame, a pin header, a printed circuit board and a plug connector system.

### LIST OF REFERENCE CHARACTERS

1 Plug connector
2 Connection area, direct
4 Connection area, indirect
6 Printed circuit board
8 Head section
10 Housing wall, plug connector
12 Housing wall, plug connector
14 Long side, plug connector head
16a, 16b Cable connection
17 Cable (wire outlet)
18 Parallel gap
20,21 Contact area
20a, 20b Contact (two contacts form a contact pair)
21a, 20b Contact (two contacts form a contact pair)
22 Base section
24 Coding lug
26 Coding lug
28 End wall, plug connector
30 Frame
32 Receiving space
34 Conductor track connection
36 Conductor track connection
38 Guide slot
40 Wall section, frame
42 Guide slot
44 Narrow side, frame
46 Narrow side, frame
48 Long side, frame
50 Long side, frame
52 Section, frame
54 Section, frame
56 Latching tab, frame
58 Latching lug, frame
60 Upper side, head
62 Protrusion, frame
64 Protrusion, frame
66 Elongated slot, frame
68 Base, frame
70 Latching hook pair
72 Latching hook pair
74 Wall section, frame
76 Pin header
78 Receiving frame, pin header
80 Long side, pin header
82 Long side, pin header
84 Section, pin header
86 Section, pin header
88 Latching lug, pin header
90 Latching lug, pin header
92 Contact pin
94 Pin holes, printed circuit board
96 Base plate, pin header
98 Wall, pin header
100 Protrusion, pin header
102 Protrusion, pin header
104 Insertion bevel
106 Lateral guide
108 Plug connector RAST 2.5 mm (Prior art)
R Spacing 1.5 mm, in each case center-center

1-9. (canceled)

10. A plug connector for direct or indirect connection to a printed circuit board or to other appliance or household appliance components, the plug connector comprising:
a housing having two opposing housing walls and a head section interconnecting said housing walls;
contact areas located between said housing walls for producing electrical or data connections to the printed circuit board or to the other appliance components;
said contact areas each having an individual contact pair with two opposing contacts being spaced from contacts of adjacent contact areas; and
said contacts of said individual contact pairs each being spaced from said contacts of an adjacent contact pair by 1.5 mm.

11. The plug connector according to claim 10, which further comprises cable connections disposed adjacent each other in said head section and spaced from each other by 1.5 mm.

12. The plug connector according to claim 11, wherein said housing has an end wall interconnecting said opposing housing walls on one side of said housing, said end wall extending over substantially an entire height of said housing walls.

13. The plug connector according to claim 12, which further comprises outwardly-disposed coding lugs disposed at least on one of said housing walls.

14. A frame, comprising a direct connection of the plug connector according to claim 10 to the printed circuit board or to the other appliance or household appliance components.

15. The frame according to claim 14, which further comprises latching hooks for latching with the printed circuit board or with the other appliance or household appliance components.

16. A pin header, comprising an indirect connection of the plug connector according to claim 10 to the printed circuit board or to the other appliance or household appliance components.

17. A printed circuit board, comprising means for connecting the printed circuit board to the plug connector according to claim 10.

18. A printed circuit board, comprising means for connecting the printed circuit board to the frame according to claim 14.

19. A printed circuit board, comprising means for connecting the printed circuit board to the pin header according to claim 16.

20. A plug connector system, comprising:
the plug connector according to claim 10;
a printed circuit board configured for a direct or an indirect connection of the plug connector; and
at least one of:
a frame for a direct connection of the plug connector to the printed circuit board, or
a pin header for an indirect connection of the plug connector to the printed circuit board.
